(19) United States
(12) Patent Application Publication
(10) Pub. No.: US 2014/0302774 A1
(43) Pub. Date: Oct. 9, 2014

(54) METHODS SYSTEMS AND APPARATUS FOR SHARING INFORMATION AMONG A GROUP OF VEHICLES

(71) Applicant: GENERAL MOTORS LLC, Detroit, MI (US)

(72) Inventors: Denis BURKE, Canton, MI (US); Keith Fry, Rochester Hills, MI (US); Daniel RUDMAN, West Bloomfield, MI (US); Shane MCCUTCHEN, Howell, MI (US); Matthew HOVEY, Oakland Township, MI (US)

(73) Assignee: GENERAL MOTORS LLC, Detroit, MI (US)

(21) Appl. No.: 13/857,039

(22) Filed: Apr. 4, 2013

(51) Int. Cl. H04H 20/57

(52) U.S. Cl. CPC H04H 20/57
USPC 455/3.05

(57) ABSTRACT

Computer-implemented methods, systems and apparatus are provided for sharing information between a group of vehicles that includes a first vehicle and one or more other vehicles. Each of the vehicles includes an onboard computer system that includes a computer processor, a receiver, a transmitter, and a tangible, non-transitory computer-readable storage medium. The storage medium stores instructions that, when executed by the processor, cause the processor to perform various acts. In accordance with the method, an onboard computer at the first vehicle generates information and automatically communicates that information to the other vehicles of the group of vehicles. Upon receiving this information at each of the other vehicles, the information can be processed at the onboard computers of each of the other vehicles, and then presented via human machine interfaces that are disposed within or inside each of the other vehicles.

### TECHNICAL FIELD

The technical field generally relates to vehicle-to-vehicle communications, and more particularly relates to methods, systems and apparatus for sharing information among a group of vehicles.

### BACKGROUND

Many vehicles today include on-board computers that perform a variety of functions. For example, on-board computers control operation of the engine, control systems within the vehicle, provide security functions, perform diagnostic checks, provide information and entertainment services to the vehicle, perform navigation tasks, and facilitate communications with other vehicles and remote driver-assistance centers. Telematics service systems, for example, provide services including in-vehicle safety and security, hands-free calling, turn-by-turn navigation, and remote-diagnostics.

On-board computers also facilitate delivery to the driver of information and entertainment, which are sometimes referred to collectively herein as infotainment. Infotainment can include, for example, data related to news, weather, sports, music, and notifications about vehicle location and nearby traffic. Infotainment can be delivered in any of a wide variety of forms, including text, video, audio, and combinations of these.

When a group of vehicles is traveling together, it is often desirable for the occupants (i.e., the drivers and their passengers) of those vehicles to have information about things that are happening inside the other vehicles in the group.

One approach to sharing information is to use a cellular telephone. An occupant in one vehicle can call an occupant in one of the other vehicles and request information from them. For instance, if a passenger in each vehicle possesses a cellular telephone, a passenger in a first vehicle can call a passenger in a second vehicle. They passengers can then exchange information with each other using their cellular telephones. For instance, one of the passengers can request information from the other such as information about how much fuel they have remaining, when they want to stop next, where they are located on the highway, what radio station they are listening to, etc.

This technique can be effective when only two vehicles are involved. However, it still requires a call between the occupants of the two vehicles. This can be undesirable when either one or both of the vehicles only have the respective drivers present therein since the driver would have to talk on their cellular phone while driving, which can be distracting or difficult.

Moreover, when there are more than two vehicles in the group, this becomes much more difficult. For instance, in scenarios where a group of families are traveling together in a caravan on a long distance trip such as a vacation or to/from a team sporting event, it becomes exponentially more difficult to implement this method for each vehicle that is added to the group.

Accordingly, it is desirable to provide alternative methods and systems for sharing information among a group of vehicles. Furthermore, other desirable features and characteristics of the present invention will become apparent from the subsequent detailed description and the appended claims, taken in conjunction with the accompanying drawings and the foregoing technical field and background.

### SUMMARY

Computer-implemented methods, systems and apparatus are provided for sharing information between a group of vehicles that includes a first vehicle and one or more other vehicles. Each of the vehicles includes an onboard computer system that includes a computer processor, a receiver, a transmitter, and a tangible, non-transitory computer-readable storage medium. The storage medium stores instructions that, when executed by the processor, cause the processor to perform various acts. In accordance with the method, an onboard computer at the first vehicle generates information and automatically communicates that information to the other vehicles of the group of vehicles. Upon receiving this information at each of the other vehicles, the information can be processed at the onboard computers of each of the other vehicles, and then presented inside the other vehicles via a human machine interface.

In one embodiment, a vehicle is provided that is configured to communicate with a group of other vehicles that have opted to belong to the group and share information with each other. The vehicle comprises a processor, a wireless communication interface, and a human machine interface. The processor generates information that is to be shared with the other vehicles belonging to the group of vehicles. The wireless communication interface can communicate the information to each of the other vehicles belonging to the group of vehicles, and can also receive other information communicated from each of the other vehicles. The processor can process the other information received from each of the other vehicles. The human machine interface can then present the other information received from each of the other vehicles.

In another embodiment, a computer-implemented method is provided for sharing information between a group of vehicles. For example, each of the vehicles belonging to the group of vehicles can generate information at a processor, and communicate, via a wireless communication interface, the information to the other vehicles in the group of vehicles. Each of the vehicles belonging to the group of vehicles can also receive, via the wireless communication interface, the information communicated from each of the other vehicles, and process that information and then present the information (received from each of the other vehicles) via a human machine interface (that is located in that particular vehicle).

In another embodiment, a system comprising a group of vehicles is provided. After joining the group, the group of vehicles are configured to share information with each other. Each vehicle belonging to the group of vehicles includes a processor, a wireless communication interface and a human machine interface. The processor generates information that is to be shared with other vehicles belonging to the group of vehicles. The wireless communication interface communicates the information to each of the other vehicles belonging to the group of vehicles. The wireless communication interface also receives information communicated from each of the other vehicles, and the processor (at each of the vehicles) can then process the information that is received (from each of the other vehicles belonging to the group of vehicles). A human machine interface within each vehicle is configured to present the processed information that was received from each of the other vehicles.

In another embodiment, a computer-implemented method for sharing information between a group of vehicles is provided. In accordance with this method, each of the vehicles that belong to the group have opted to share information with other vehicles in the group. In the following example, the group will be set forth as including a first vehicle and at least one (or more) other vehicle(s). In accordance with this computer-implemented method, information can be generated at a first processor within the first vehicle, and communicated, via a first wireless communication interface within the first vehicle, to the one or more other vehicles. Each of the (one or more) other vehicles can then receive the information (e.g., via a second wireless communication interface located within that particular one of the other vehicles), process the information, and present the processed information via a human machine interface.

### DESCRIPTION OF THE DRAWINGS

The exemplary embodiments will hereinafter be described in conjunction with the following drawing figures, wherein like numerals denote like elements, and wherein:

FIG. 1 is a diagram that illustrates a vehicle-to-vehicle communication system in accordance with some of the disclosed embodiments.

FIG. 2 is a block diagram of in-vehicle systems of a vehicle and a wireless communication device located in the vehicle in accordance with some of the disclosed embodiments.

FIG. 3 is a flow chart of a method for sharing information among a group of vehicles and displaying that information in each of the vehicles in accordance with some of the disclosed embodiments.

FIG. 4 is a flow chart of a method for creating a group of vehicles and establishing a communication session among the group of vehicles in accordance with some of the disclosed embodiments.

FIG. 5 is a flow diagram of a method for pushing information from (at least) a first vehicle to other vehicles that belong to a group of vehicles in accordance with some of the disclosed embodiments.

FIG. 6 is a flow diagram of a method for pulling information from (at least) a first vehicle to distribute that information to other vehicles that belong to a group of vehicles in accordance with some of the disclosed embodiments.

FIG. 7 is one non-limiting representation of information that can be presented at a user interface on a display of an infotainment system in accordance with some of the disclosed embodiments.

FIG. 8 is another non-limiting representation of information that can be presented at a user interface on a display of an infotainment system in accordance with some of the disclosed embodiments.

### DETAILED DESCRIPTION

Various embodiments of the present disclosure are disclosed herein. The disclosed embodiments are merely examples that may be embodied in various and alternative forms, and combinations thereof. The following detailed description is merely exemplary in nature and is not intended to limit the application and uses. The word “exemplary” is used exclusively herein to mean “serving as an example, instance, or illustration.” Any embodiment described herein as “exemplary” is not necessarily to be construed as preferred or advantageous over other embodiments. As used herein, for example, “exemplary” and similar terms, refer expansively to embodiments that serve as an illustration, specimen, model or pattern. Furthermore, there is no intention to be bound by any expressed or implied theory presented in the preceding technical field, background, brief summary or the following detailed description.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In some instances, well-known components, systems, or methods have not been described in detail in order to avoid obscuring the present disclosure. Therefore, specific operational and functional details disclosed herein are not to be interpreted as limiting, but merely as a basis for the claims and as a representative basis for teaching one skilled in the art.

Overview

Before describing some of the disclosed embodiments, it should be observed that the disclosed embodiments generally relate to systems, methods, computer-readable media, computer-executable instructions, and apparatus for sharing information between a group of vehicles that includes a first vehicle and one or more other vehicles. Thus, the systems, in various embodiments, include vehicles, such as automobiles, and onboard computer sub-systems thereof, and in some embodiments also include one or more remote servers.

The group of vehicles can be a particular pre-defined group of companion vehicles that are traveling together and have opted to share information with other vehicles in the group. The group of vehicles can be created, for example, by generating at least one unique key for the group at a group leader, distributing the at least one unique key to each of the vehicles that are invited to join the group, and then establishing a communication session among the vehicles.

In accordance with the disclosed embodiments, information generated at the first vehicle is automatically communicated to the other vehicles of the group of vehicles. Upon receiving this information at each of the other vehicles, the information can be presented via a human machine interface inside the other vehicles. For example, in one implementation, the human machine interface in each vehicle can be a display (e.g., located inside the cabin of that vehicle), and the information received at each of the other vehicles can be displayed on the display in each vehicle.

The information that is generated at the first vehicle can be any type of information that is generated at first vehicle, and can be of a variety of different types.

For example, in one embodiment, the information can be (or can include) information about the first vehicle. This information can be information generated by or based on information from a sensor within the vehicle, or information available on a bus within the first vehicle, such as diagnostic information about the first vehicle that is generated by or within the first vehicle. In one implementation, this diagnostic information can be generated by a particular system (or sub-system) within the first vehicle, and includes diagnostic information about that particular system within the first vehicle.

In another embodiment, the information can be (or can include) metadata for any information about the first vehicle, such as metadata that indicates something that is happening inside the first vehicle (e.g., metadata that indicates information about an infotainment system of the first vehicle, such as setting information that indicates a setting of the infotainment system).

In another embodiment, the information can be (or can include) navigation data associated with the first vehicle, such as relative location information of the first vehicle with respect to the other vehicles of the group, speed of the first vehicle, etc. This navigation data can then be displayed on a display within each of the vehicles. In one implementation, the relative location information can be displayed on a display in each of the other vehicles on a map along with locations of each of the other vehicles that belong to the group.

In another embodiment, the information can be (or can include) messaging or status information that is input by a passenger in the first vehicle.

In another embodiment, the information can be (or can include) information generated by or associated with any applications that are running in the first vehicle.

In another embodiment, the information can be (or can include) information generated by applications that are running on a portable wireless communication device that is presently in the vehicle.

In another embodiment, the information can be (or can include) warning information that is automatically generated by the first vehicle and automatically communicated in an alert message transmitted from the first vehicle.

These are only a few non-limiting examples of the types of information that can be communicated from the first vehicle to other vehicles in the group, and then displayed within the other vehicles. Additional examples will be described below.

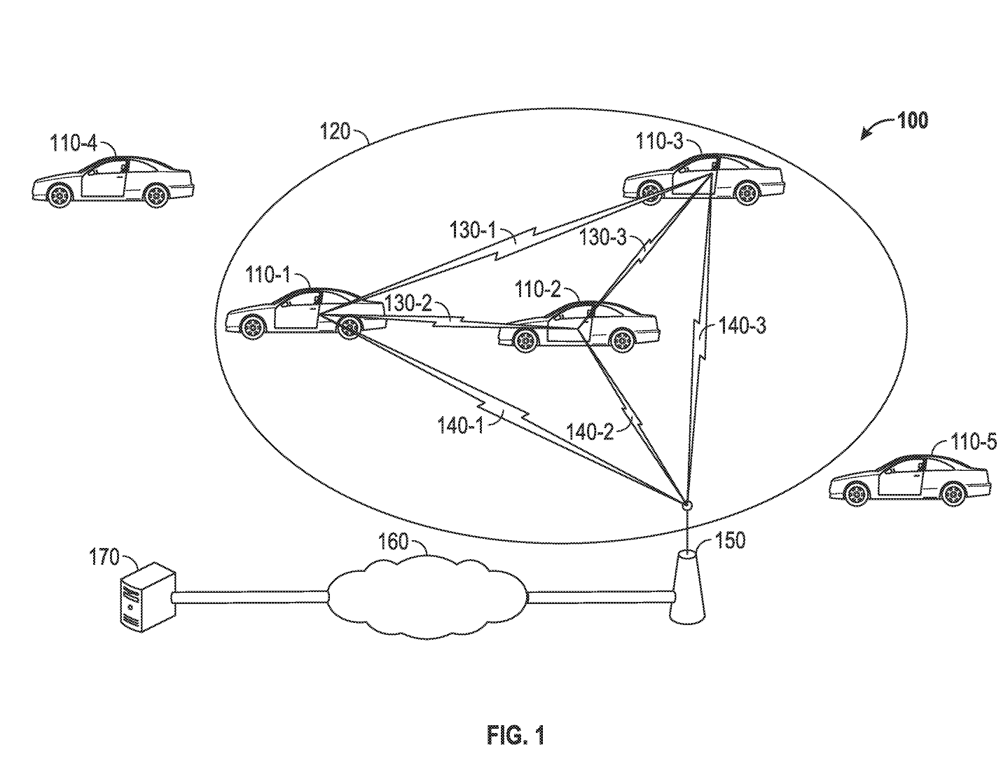

FIG. 1 is a diagram that illustrates a vehicle-to-vehicle communication system 100 in accordance with some of the disclosed embodiments.

The vehicle-to-vehicle communication system 100 includes a group 120 of vehicles 110-1 . . . 110-3 that includes a first vehicle 110-1 and one or more other vehicles 110-2, 110-3. As used herein, the term “group” when used with reference to vehicles refers to at least two vehicles that have opted to share information with each other. It is noted that in this particular non-limiting example, the group 120 includes three vehicles; however, the group 120 can include any number of vehicles. For purpose of describing exemplary information sharing the vehicles 110-1 . . . 110-3 in this example group will be referred to below as a “first” vehicle 110-1 and two “other” vehicles 110-2, 110-3. Additional vehicles 110-4, 110-5 are depicted that are not members of the group 120. The group 120 of vehicles 110-1 . . . 110-3 can be, for example, a particular pre-defined group 120 of companion vehicles that are traveling together and have opted to share information with other vehicles 110-2, 110-3 in the group 120.

The vehicle-to-vehicle communication system 100 may also include, in some implementations, communication infrastructure 150 that is coupled to an intermediate server 170 (that is external to the vehicle) by a network 160 such as the Internet. Communication infrastructure 150 can generally be any public or private access point that provides an entry/exit point for onboard computer systems (within the vehicles) to communicate with a wide area network 160, such as the Internet.

The communication infrastructure 150 can include, for example, long-range communication nodes (e.g., cellular base stations 150 or communication satellites 150) that are communicatively connected to the communication network 160, such as one or more of a cellular telephone network and the Internet.

The long-range communication nodes allow the vehicle vehicles 110-1 . . . 110-3, and the server 170 to communicate with each other to share data, such as packetized data and voice data.

Thus, each vehicle 110-1, 110-2, 110-3 can communicate with any other vehicle, even if the other vehicles are not nearby, such as, by way of communications from the vehicle 110-1, 110-2, 110-3 to the remote server 170, and from the remote server 170 to the other vehicles, or by way of communications through the communication network 160 without involvement of a central server.

The communication infrastructure 150 also allows onboard computer systems that are embedded in each vehicle 110 to communicate with one or more local or remote devices such as a local remote control device, a cellular phone, another personal device, and a remote computer server. For communicating with a remote device, onboard computer systems can facilitate wired or wireless communications with an external communication network. Exemplary external communication networks include, but are not limited to cellular networks, Voice over Internet Protocol (VoIP) networks, local area networks (LANs), wide area networks (WANs), personal area networks (PANs), and other communication networks.

Short-range communications can allow the vehicles 101-1, 110-2, 110-3 to communicate directly with each other. In other words, the vehicles 101-1, 110-2, 110-3 communicate directly with one another as part of an ad-hoc network without relying on intervening infrastructure, such as node 150 or cellular network. Such communications are sometimes referred to as vehicle-to-vehicle (V2V) communications. The DSRC standards facilitate wireless communication channels specifically designed for automotive vehicles so that participating vehicles can wirelessly communicate directly on a peer-to-peer basis with any other participating vehicle.

In addition, the vehicles 101-1, 110-2, 110-3 can also communicate with the short-range nodes 150 during short-range communications. Such communications are sometimes referred to colloquially as vehicle-to-infrastructure, or V2I, communications. For example, the communication infrastructure 150 can include, for example, short-range communication nodes (e.g., wireless access points) that wireless devices, such as an onboard computer system of a vehicle and portable wireless communication devices, such as smart phones and laptop computers, to connect to the communication network 160. Communications between wireless devices and wireless access points are typically facilitated using DSRC, IEEE 802.x, Wi-Fi®, Bluetooth®, or related or similar standards. Short-range communication nodes 150 are commonly positioned in homes, public accommodations (coffee shops, libraries, etc.), and as road-side infrastructure such as by being mounted adjacent a highway or on a building in a crowded urban area.

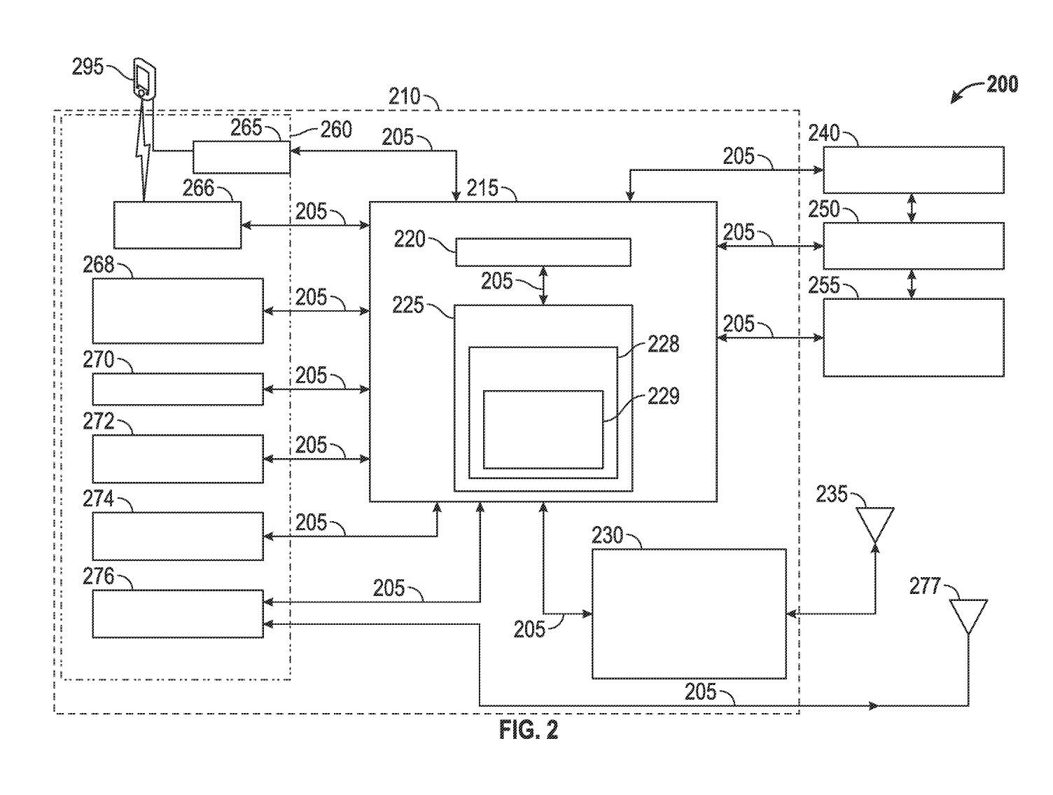

Each of the vehicles can include various in-vehicle systems or sub-systems. One non-limiting example embodiment of such in-vehicle systems will be described below with reference to FIG. 2. The in-vehicle systems include on-board computer systems and wireless communication devices (i.e., transceivers and interfaces) embedded within the vehicle itself that allow each of the vehicles to communicate information over-the-air either directly with each other over wireless communication links 130-1 . . . 130-3 between the vehicles, or indirectly through the communication infrastructure 150 over wireless communication links 140-1 . . . 140-3. In some implementations, in-vehicle wireless communication device can be paired with a portable wireless communication device (e.g., mobile telephone) that is present in the vehicle, and can use a data channel of that mobile telephone to exchange information with the other vehicles.

The physical layer used to implement these wireless communication links can be implemented using any known or later-developed wireless communication or radio technology. In some embodiments, the wireless communication links can be implemented, for example, using one or more of Dedicated Short-Range Communications (DSRC) technologies, cellular radio technology, satellite-based technology, wireless local area networking (WLAN) or WI-FI® technologies such as those specified in the IEEE 802.x standards (e.g. IEEE 802.11 or IEEE 802.16), WIMAX®, BLUETOOTH®, near field communications (NFC), the like, or improvements thereof (WI-FI is a registered trademark of WI-FI Alliance, of Austin, Tex.; WIMAX is a registered trademark of WiMAX Forum, of San Diego, Calif.; BLUETOOTH is a registered trademark of Bluetooth SIG, Inc., of Bellevue, Wash.).

Direct Vehicle-to-Vehicle Communication

In one implementation, the vehicles 110 can communicate information over-the-air directly with each other over wireless communication links 130-1 . . . 130-3 between the vehicles. For example, when vehicle 110-1 is in relatively close proximity with other vehicles 110-2, 110-3, such as by being within range allowing short-range or medium-range communications between the vehicles, the vehicles can communicate directly with each other using for example, WLAN or DSRC communications.

Indirect Vehicle-to-Vehicle Communication

In another implementation, the vehicles 110 can communicate information with each other indirectly through the communication infrastructure 150 over wireless communication links 140-1 . . . 140-3. Depending on the implementation, the communication infrastructure 150 can be a cellular base station, a WLAN access point, a satellite, etc. that is in communication with server 170.

FIG. 2 is a block diagram of in-vehicle systems 200 of a vehicle 110 and a portable wireless communication device 295 located in the vehicle 110 in accordance with some of the disclosed embodiments. The vehicle can be, for example, an automotive vehicle or automobile. FIG. 2 will be described below with reference to FIG. 1. The portable wireless communications device 295 can include devices, such as personal or tablet computers, cellular telephones, smart phones, etc. The portable wireless communication device 295 is not part of the vehicle, but is illustrated in FIG. 2 since it can be utilized to generate or to input information that this shared between vehicles in accordance with some of the disclosed embodiments. As will be described below, the portable wireless communication device 295 can be communicatively coupled to various components of an onboard computer system 210 via a wireless or wired connection.

The in-vehicle systems 200 include the onboard computer system 210, in-vehicle sensors 240, vehicle diagnostics systems 250, and other vehicle systems 255. Each of the in-vehicle systems 200 is coupled to each other via an in-vehicle bus 205. As used herein, the bus 205 can include any internal vehicle bus. The bus 205 includes various wired paths that are used to interconnect the various systems and route information between and among the illustrated blocks of FIG. 2. The components of the onboard computer 210 are coupled to one another by one or more bus line(s) 205.

The onboard computer system 210 can include, or can be connected to, a computer 215, wireless communication interfaces 230, and an infotainment system 260. It is noted that although certain blocks are indicated as being implemented with the onboard computer system 210 (such as wireless communication interfaces 230, navigation systems 276, input and output devices 268, for example), in other embodiments, any of these modules can be implemented outside the 210.

The computer 215 includes at least one computer processor 220 that is in communication with a tangible, non-transitory computer-readable storage medium 225 (e.g., computer memory) by way of a communication bus 205 or other such computing infrastructure. The processor 220 is illustrated in one block, but may include various different processors and/or integrated circuits that collectively implement any of the functionality described herein. The processor 220 includes a central processing unit (CPU) that is in communication with an I/O interface (including those not shown within the infotainment system 260), and the computer-readable storage medium 225. An I/O interface (not illustrated) may be any entry/exit device adapted to control and synchronize the flow of data into and out of the CPU from and to peripheral devices such as input output devices 268.

As will be explained in greater detail below, the processor 220 can receive information from each of the other blocks illustrated in FIG. 2, process this information, and generate communications signals that convey selected information to the other vehicles that belong to the group so that the selected information can be processed at each of the other vehicles that belong to the group and rendered at a human machine interface of that vehicle such as a display or audio system.

For example, the processor 220 can receive information from one or more of the other blocks illustrated in FIG. 2 (such as one or more of the sensors 240, diagnostics systems 250, etc.), process this information, and generate communications signals that convey a warning message to the other vehicles; in turn, a processor at each of the other vehicles that belong to the group 120 can process the received signals and generate and display a warning message which is visible to the driver and/or passengers in each of the other vehicles that belong to the group. The warning could also be in the form of a sound (e.g., an audible tone), a flashing light and other signal that is designed to attract the attention of the occupants. In some embodiments, the displays 270 and/or audio systems 272 can be used to provide visual and/or audible warning messages to the driver or others that a hazard exists. For example, sound and/or light systems can be activated (when appropriate) to warn other people, animals, or vehicles of a pending hazardous condition. In such cases, the warning system could activate the vehicle headlights, tail lights, horn and/or the vehicle-to-vehicle, Internet or infrastructure communication system to inform other vehicles, a traffic control station or other base station. This way the driver or others can be warned of potential problems.

As another example, the processor 220 can receive information from one or more of the other blocks illustrated in FIG. 2 (such as one or more of the sensors 240, the navigation systems 276, etc.), process this information, and generate communications signals that convey a location message to the other vehicles that belong to the group 120. The location message can include, for example, data relating to a GPS determined position of the vehicle, the velocity at which the vehicle is traveling, and the course heading in which the vehicle traveling, etc. A processor at each of the other vehicles that belong to the group 120 can process the location messages received from each of the other vehicles, and generate data that can be displayed on one of its displays to indicate information about each of the other vehicles that belong to the group 120. In some embodiments, this information can be used to create a dynamic map that shows the relative location of each other vehicle of the group 120 with respect to the vehicle

The computer-readable medium 225 can include any known form of computer-usable or computer-readable medium. The computer-readable (storage) medium 225 can be any type of memory technology including any types of read-only memory or random access memory or any combination thereof. This encompasses a wide variety of media that include, for example but not limited to, an electronic, magnetic, optical, electromagnetic, infrared, or semiconductor system, apparatus, device, or propagation medium. Some non-limiting examples can include, for example, volatile media, non-volatile media, removable media, and non-removable media. The term computer-readable medium and variants thereof, as used in the specification and claims, refer to any known computer storage media. In some embodiments, storage media includes volatile and/or non-volatile, removable, and/or non-removable media. For example, storage media could include any of random-access memory (RAM), read-only memory (ROM), electrically erasable programmable read-only memory (EEPROM), solid state memory or other memory technology, CD ROM, DVD, other optical disk storage, magnetic tape, magnetic disk storage or other magnetic storage devices, and any other medium that can be used to store desired data. For sake of simplicity of illustration, the computer-readable medium 225 is illustrated as a single block within computer 215; however, the computer-readable storage medium 225 can be distributed throughout the vehicle including in any of the various blocks illustrated in FIG. 2, and can be implemented using any combination of fixed and/or removable storage devices depending on the implementation.

The computer-readable storage medium 225 stores instructions 228 that, when executed by the processor, cause the processor 220 to perform various acts as described herein. The instructions 228 may be stored in the medium 225 in one or more modules. For instance, the instructions 229 include an information sharing and display module 229 that can be loaded and executed at processor 220 as will be described in further detail below. The instructions 228 may be embodied in the form of one or more programs or applications (not shown in detail). While instructions 228 and the information sharing and display module 229 are shown generally as residing in the computer-readable storage medium 225, various data, including the instructions 228 are in some embodiments stored in a common portion of the storage medium, in various portions of the storage medium 225, and/or in other storage medias described further below. The instructions can then be loaded at the processor 220 and executed.

The onboard computer system 210 includes one or more wireless communication interfaces 230 facilitating communications to and from the system 210. The wireless communication interfaces 230 are illustrated as being part of the onboard computer system 210, but can be implemented via one or more separate chipsets. While the wireless communication interfaces 230 are illustrated in a single box, it will be appreciated that this box can represent multiple different wireless communication interfaces each of which can include multiple ICs for implementation of the receivers, transmitters, and/or transceivers that are used for receiving and sending signals of various types, including relatively short-range communications or longer-range communications, such as signals for a cellular communications network.

The wireless communication interfaces 230 include at least one receiver and at least one transmitter that are operatively coupled to at least one processor such as processor 220. The wireless communication interfaces 230 can enable the vehicle to establish and maintain one or more wireless communications links (e.g., via cellular communications, WLAN, Bluetooth, and the like). The wireless communication interfaces 230 can perform signal processing (e.g., digitizing, data encoding, modulation, etc.) as is known in the art. The wireless communication interfaces 230 can use communication techniques that are implemented using multiple access communication methods including frequency division multiple access (FDMA), time division multiple access (TDMA), code division multiple access (CDMA), orthogonal frequency division multiple access (OFDMA) in a manner to permit simultaneous communication with and between vehicles.

In accordance with the disclosed embodiments, the wireless communication interfaces 230 can be used to exchange information with other vehicles that belong to the group 120. The wireless communication interfaces 230 are configured to transmit and receive a variety of information (e.g., information provided over a bus within the vehicle or over wide area networks, such as the Internet, information such as video data, voice data, e-mail, information from diagnostics systems, information detected by the sensors 240, information provided by the navigation systems 276, etc.).

The wireless communication interfaces 230 include any number of short range transceivers and long range transceivers depending on the particular implementation.

The wireless communication interfaces 230 can include wireless communication interfaces for relatively short-range communications that employ one or more short-range communication protocols, such as a dedicated short range communication (DSRC) system (e.g., that complies with IEEE 802.11p), a WiFi system (e.g., that complies with IEEE 802.11a, b, g, IEEE 802.16, WI-FI®, BLUETOOTH®, infrared, IRDA, NFC, the like, or improvements thereof). In one embodiment, one of the wireless communication interfaces 230 are configured as part of a short-range vehicle communication system, and allow the vehicle to directly communicate (transmit and receive) information with other nearby vehicles that belong to the group 120.

The wireless communication interfaces 230 can include wireless communication interfaces for longer-range communications such as cellular and satellite based communications that employ any knows communications protocols. In one embodiment, one of the wireless communication interfaces 230 is configured to communicate over a cellular network, such as a third generation (3G) or fourth generation (4G) cellular communication network.

Thus, the wireless communication interfaces can be implemented using any known wireless communications technologies including any of those described above.

The onboard computer 210 is configured for receiving, processing and transmitting information received from sensors 240 that are part of the vehicle 110. The sensor 240 can sense, for example, environmental information and/or vehicle operation information (e.g., speed/acceleration of the vehicle, wind conditions, internal or external temperature, precipitation, visibility, wheel traction, braking, suspension, etc.), and communicate this information to the onboard computer 210. The sensors 240 may be adapted to transmit and receive digital and/or analog signals. Illustrative sensors include analog or digital sensors, mechanical property sensors, electrical property sensors, audio or video sensors, or any combination thereof.

The sensors 240 can also include sensors at various locations that are used to monitor apparatus that are used for controlling the vehicle such as a brake systems, steering systems, etc. The sensors 240 can also include a velocity sensor such as a wheel speed sensor or radar velocity meter that provides an accurate measure of the vehicle velocity relative to the ground. The sensors 240 can also include temperature sensors, Pedal Position Sensors (PPSs), Throttle Position Sensors (TPSs), Mass Air Flow (MAF) sensors, Manifold Absolute Pressure (MAP) sensors, Tire Pressure Sensors, Crash Sensors, Fuel Level Sensors, Battery Charge State sensors, Airbag sensors, Engine Coolant Temperature sensors, etc. The sensors 240 can also include infrared sensors mounted on the vehicle that can be used to determine the road temperature, the existence of ice or snow.

The sensors 240 can also include one of more cameras that are mounted on the vehicle for interrogating environment nearby the host vehicle for such functions as blind spot monitoring, backup warnings, anticipatory crash sensing, visibility determination, lane following, and any other visual information. Generally, the cameras will be sensitive to infrared and/or visible light, however, in some cases a passive infrared camera will the used to detect the presence of animate bodies such as deer or people on the roadway in front of the vehicle. Frequently, infrared or visible illumination will be provided by the host vehicle.

The sensors 240 can include lidar, radar, vision and/or other object sensing mechanisms. For example, the sensors 240 can include radar to scan an environment close to and further from the vehicle than the range of the cameras and to provide an initial warning of potential obstacles in the path of the vehicle. The radar an also be used when conditions of a reduced visibility are present to provide advance warning to the vehicle of obstacles hidden by rain, fog, snow etc. Pulsed, continuous wave, noise or micropower impulse radar systems can be used as appropriate. Also, Doppler radar principles can be used to determine the object to host vehicle relative velocity. Laser or terahertz radar can be used to illuminate potential hazardous objects in the path of the vehicle. Since the vehicle will be operating on accurate mapped roads, the precise location of objects discovered by the radar or camera systems can be determined using range gating and scanning laser radar as described above or by phase techniques.

The diagnostics systems 250 can include any known vehicle diagnostics technologies that can provide advanced warning of potential vehicle component issues. The diagnostics systems 250 can include diagnostics for engine systems, transmission systems, emissions systems, air bag systems, braking systems, navigations systems, etc. The diagnostics systems 250 can include, or reply on input from, various sensors 240 that illustrated in a separate block for sake of simplicity of illustration.

The infotainment system 260 includes at least the following: ports 265 (e.g., USB ports), one or more Bluetooth interface(s) 266, input/output devices 268, one or more display(s) 270, one or more audio system(s) 272, radio systems 274, and a navigation system 276.

The ports 265 and Bluetooth interface 266 allow for external computing devices (including portable wireless communication device 295) to connect to the onboard computer system 210 and the infotainment system 260. The infotainment system 260 is used to provide passengers in the vehicle with information and/or entertainment in various forms including, for example, music, news, reports, navigation, weather, and the like, received by way of radio systems 274, Internet radio, podcast, compact disc, digital video disc, other portable storage device, video on demand, and the like.

The input/output devices 268 can be any device(s) adapted to provide or capture user inputs to or from the onboard computer 210. For example, a button, a keyboard, a keypad, a mouse, a trackball, a speech recognition unit, any known touchscreen technologies, and/or any known voice recognition technologies, monitors or displays 270, warning lights, graphics/text displays, speakers, etc. could be utilized to generate information in one vehicle that is eventually displayed in another vehicle that belong to the group. Thus, although shown in one block for sake of simplicity, the input/output devices 268 can be implemented as separate output devices 268 and separate input devices 268 in some implementations.

As one example, the input/output devices 268 can be implemented via a display screen with an integrated touch screen, and/or a speech recognition unit, that is integrated into the system 260 via a microphone that is part of the audio systems 272.

In one embodiment, the input/output devices 268, display(s) 270, and audio system(s) 272 can collectively provide a human machine interface (HMI) inside the vehicle.

Further, it is noted that exemplary HMI sub-systems that are not illustrated can include any of a touch-sensitive or other visual display, a keypad, buttons, or the like, a speaker, microphone, or the like, operatively connected to the processor 220. The input can be provided in ways including by audio input. Thus, for instance, the sub-system or onboard computer system 210 in some embodiments includes components allowing speech-to-data, such as speech-to-text, or data-to-speech, such as text-to-speech conversions. In another case, the user inputs selected information to a personal device of the user, such as a personal or tablet computer or a smart phone, which in turn communicates the information to the onboard computer system by wireless or wired communication.

The displays 270 can include any types and number of displays within the vehicle. For example, the displays 270 can include a visual display screen such as a navigation display screen or a heads-up-display projected on the windshield or other display system for providing information to the vehicle operator. One type of display may be a display made from organic light emitting diodes (OLEDs). Such a display can be sandwiched between the layers of glass that make up the windshield and does not require a projection system. The displays 270 can include multiple displays for a single occupant or for multiple occupants, e.g., directed toward multiple seating positions in the vehicle.

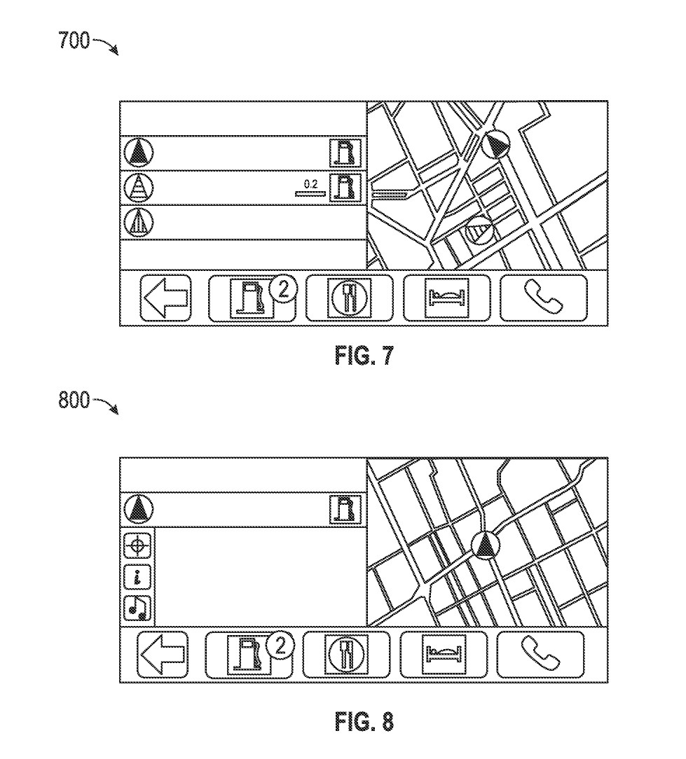

Any type of information can be displayed on the displays 270 including any of the information that is described below. In one specific non-limiting example that described below with reference to FIGS. 7 and 8, the information being displayed on the display can include icons/symbols that reflect the location of the vehicle on a map along with other icons/symbols that reflect the relative locations of other vehicles that are part of the group, information about which radio stations other vehicles are currently playing, warning or other emergency messages provided by other vehicles (e.g., some type of condition, traffic or road events such as traffic delays, accidents, or current conditions that could result in an accident), etc.

The navigation systems 276 can include a global positioning system (GPS) device for establishing a global position of the vehicle. The GPS device includes a processor and one or more GPS receivers that receive GPS radio signals via antenna 277. These GPS receivers receive differential correction signals from one or more base stations either directly or via a geocentric stationary or LEO satellite, an earth-based station or other means. This communication may include such information as the precise location of a vehicle, the latest received signals from the GPS satellites in view, other road condition information, emergency signals, hazard warnings, vehicle velocity and intended path, and any other information. The navigation systems 276 can also regularly receive information such as updates to the digital maps, weather information, road condition information, hazard information, congestion information, temporary signs and warnings, etc. from a server 170. The navigation systems 276 can include a map database subsystem (not illustrated) that includes fundamental map data or information such as road edges, the locations of stop signs, stoplights, lane markers etc. that can be regularly updated information with information from a server such as server 170.

The navigation systems 276 can receive information from various sensors 240 as is known in the art. For example, in one implementation, the sensors 240 can include an inertial navigation system (INS) (also referred to as an inertial reference unit (IRU)) that includes one or more accelerometers (e.g., piezoelectric-based accelerometers, MEMS-based accelerometers, etc.), and one or more gyroscopes (e.g., MEMS-based gyroscopes, fiber optic gyroscopes (FOG), accelerometer-based gyroscopes, etc.). For instance, three accelerometers can be implemented to provide the vehicle acceleration in the latitude, longitude and vertical directions and three gyroscopes can be employed to provide the angular rate about the pitch, yaw and roll axes. In general, a gyroscope would measure the angular rate or angular velocity, and angular acceleration may be obtained by differentiating the angular rate.

The navigation systems 276 can be implemented using any component or combination of components capable of determining a direction of travel of the vehicle 110. In one embodiment, navigation systems 276 can communicate (directly or indirectly) information about the direction, speed, acceleration and other variable affecting travel of that vehicle to other vehicles in order to allow the vehicles to determine and display the relative motion of the group 120 of vehicles 110 with respect to one another.

As noted above, the computer-readable storage medium 225 can store computer-executable instructions 228 that include an information sharing and display control module 229. In response to a trigger event (e.g., detecting that a communication session has been started or established between the group 120, for instance, when a trip has started), the information sharing and display control module 229 can be loaded and executed at each of the vehicles 110-1 . . . 110-3 that are part of the group 120 to allow for information sharing between vehicles 110-1 . . . 110-3. As will be described in greater detail below, this allows information generated at one of the vehicles (e.g. at the first vehicle 110-1) to be processed and then communicated to the other vehicles (e.g., vehicles 110-2, 110-3) of the group 120 so that information can be shared information by the group 120 of vehicles 110-1 . . . 110-3. This information can then be presented (e.g., displayed) in each recipient vehicle 110-2, 110-3. For example, upon receiving this information at each of the other vehicles 110-2, 110-3, the information can be presented via a human machine interface (HMI) inside the other vehicles 110-2, 110-3. For instance, in one implementation, the human machine interface in each vehicle can be a display located inside the cabin of that vehicle 110-2, 110-3, such as a display that is part of an infotainment system. In this case, the information received at each of the other vehicles 110-2, 110-3 can then be displayed on the display in each vehicle. As noted above, the HMI may also include an audio system within the vehicle that is used in conjunction with or as an alternative to the display to present the information to the passengers in the other vehicles 110-2, 110-3.

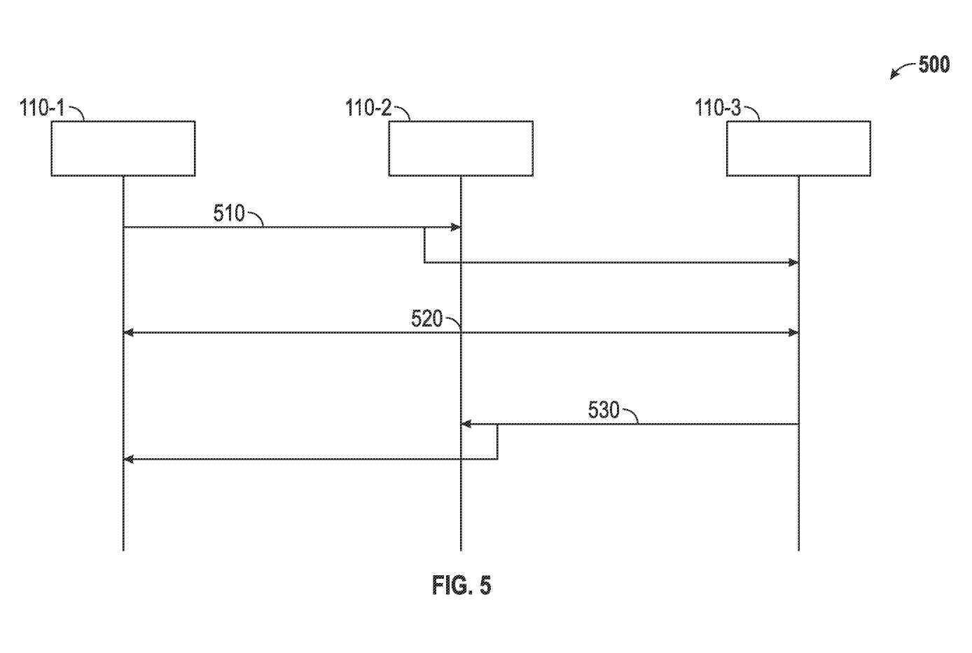

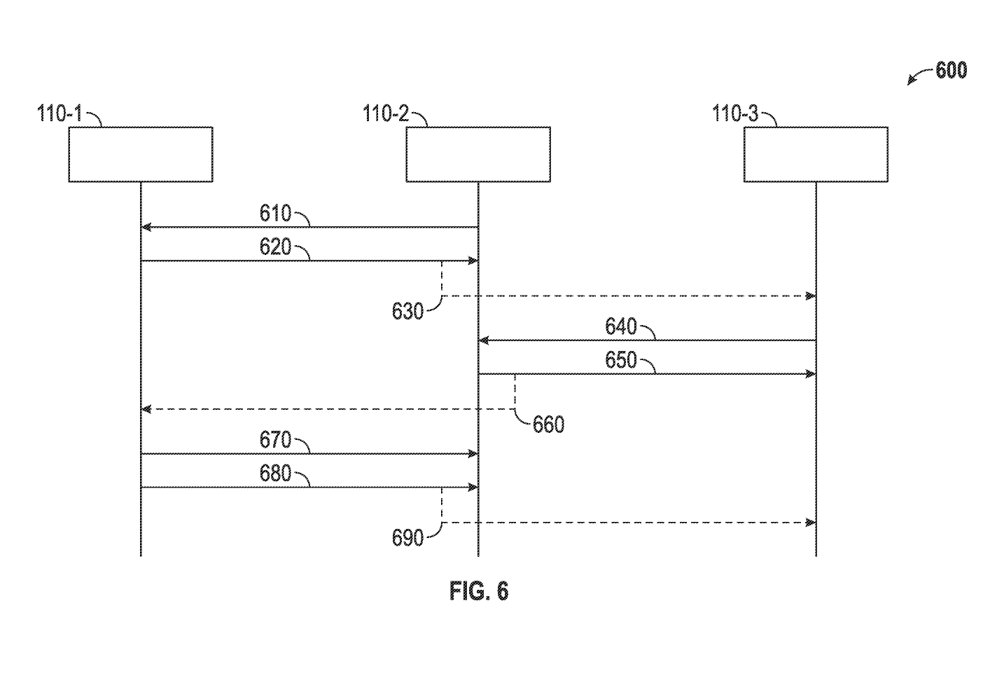

As will be described below with reference to FIGS. 5 and 6, the information can be communicated (or “pushed”) from the first vehicle 110-1 automatically on a regular basis (e.g., at regular intervals or in response to an event that takes place), or can be communicated from the first vehicle 110-1 in response to a request from a particular vehicle 110-2, 110-3 within the group (or “pulled”).

Further, as will be described below with reference to FIG. 2, the information that is generated at the first vehicle 110-1 can be any type of information that is generated at the first vehicle 110-1, and can be of a variety of different types.

Information that can be Communicated from the First Vehicle

As noted above, the information that is generated at a vehicle 110 (such as the first vehicle 110-1) and communicated to other vehicles 110 (such as vehicles 110-2, 110-3) of the group 120 can be any type of information that is generated at or by a vehicle 110, and can be of a variety of different types. In general terms, the information can be (or can include) information about a vehicle 110 that is capable of being presented at or displayed on user interfaces located within the other vehicles that belong to the group 120. A few non-limiting examples of types of information that can be communicated and displayed include, but are not limited to, information relevant to vehicle drivers and passengers, telematics information, entertainment information (such as music or video) or other types of information relevant to vehicle occupants (e.g., drivers and/or their passengers).

For instance, this information can be general status messages generated by the vehicle that convey information about the status of a system within the vehicle. A few non-limiting examples of general status messages can include, for example, “Destination set to 100 Pine Avenue”, “Vehicle is parked”, etc.

This information can also be information: (1) generated by, or based on, information from, a sensor within the vehicle, (2) control information generated within the first vehicle, (3) diagnostic information about the first vehicle, etc.

In addition, this information can be information available on a bus 205 within a vehicle 110, such as diagnostic information about the vehicle 110 that is generated by or within the vehicle 110.

In one implementation, this diagnostic information can be generated by a particular system (or sub-system) within the vehicle 110, and includes diagnostic information about that particular system (or sub-system) to provide an indication or status of something that is taking place within the vehicle. Those skilled in the art will readily appreciate the types of information that are encompassed by onboard diagnostic information. Standardized onboard diagnostic information can include hundreds or thousands of different signals. Diagnostic information can include status information, metadata that indicates the condition of the vehicle, data that is accessible via an original equipment manufacturers API. For example, diagnostic information generated within a vehicle 110 can include information about oil pressure/temperature, tire pressure/temperature, remaining fuel/gas levels (e.g., a fuel gauge readout in the first vehicle that indicates a remaining fuel level of the first vehicle), engine coolant temperature, battery charge state, ABS malfunction, etc.

In another embodiment, the information can be (or can include) metadata for any information about a vehicle 110, such as metadata that indicates something that is happening inside the vehicle 110. As used herein, the term “metadata” refers to a set of data that describes and gives information about other data (e.g., data about data content, or data providing information about one or more aspects of the data). In some cases, metadata is descriptive metadata or data content about individual instances of application data, as opposed to actual audio or video content. One example of metadata in the context of the vehicle's infotainment system would be metadata that indicates information about an infotainment system of a vehicle 110, such as setting information that indicates a setting of the infotainment system. For instance, this metadata could be information such as which particular radio station or media channel that is currently selected by and/or being listened to in the vehicle 110. The information can include information identifying a media profile from an infotainment system of the vehicle 110, such as, the name of the artist (e.g., composer, writer, singer, etc.), and/or the name of a particular file or song that is currently being listened to in the vehicle 110, etc. A few other non-limiting examples of metadata can include, for example, radio station information, route/destination information, information about a phone call being placed from the vehicle, etc.

Examples of sensor information can include any information that is directly produced by a sensor of a vehicle 110, or information derived from (or generated based on) information from one or more sensors of a vehicle 110. Sensor information can include status information about events that are taking place or settings inside the cabin of a vehicle 110. A few non-limiting examples of sensor information can include, for example, information generated by any of the various sensors described above, or information that is derived from the information generated by any of the various sensors described above. In addition, sensor information can be combined with other types of information described herein, and provided to the other vehicles 110. For instance, pressure sensors located within the seats of the first vehicle 110-1 can generate information about whether or not those seats are occupied, and information input into the infotainment system can indicate which passenger occupies a particular seat within the first vehicle 110-1. This information can then be communicated to the other vehicles 110-2, 110-3 of the group 120 so that their occupants know who is sitting where, who is driving the vehicle, etc.

In another embodiment, the information can be (or can include) navigation data associated with a vehicle 110, such as vehicle location information (e.g., a GPS readout), relative location information of the vehicle 110 with respect to the other vehicles 110 of the group 120, speed of the vehicle 110 from a speedometer readout, etc. This navigation data can then be displayed on a display within each of the vehicles. In one implementation, the relative location information can be displayed on a display in each of the other vehicles 110 on a map along with locations of each of the other vehicles 110 that belong to the group 120. The information can include information indicating a location of the vehicle (e.g., the location could be, for instance, a geographic location, such as a state, county, city, or other region, latitude/longitude coordinates, or other geographic coordinates or indicator.)

The information can include information identifying the vehicle or a user/passenger within the vehicle.

The information can also include an indication of how close in proximity each of the vehicles of the various group members are from each other. This could be determined in a number of ways including by measuring signals received from each other (e.g., as part of short-range communications between the vehicles), or by comparing location information (e.g., latitude-longitude information) associated with each of the vehicles 110-1, 110-2, 110-3 at the onboard computer system 210 or by receiving such information at the remote server 170. Location information may be generated in the vehicles or the remote servers, such as by use of a global navigation satellite system (GNSS), such as the global positioning system (GPS). For embodiments in which the comparison is performed at the onboard computer 210 of, for example, the vehicle 110-1, the vehicle 110-1 can obtain the location information for the other vehicles 110-2, 110-3 directly from the other vehicles 110-2, 110-3 (e.g., by short or long-range communications), or from a remote device, such as a location register or the remote server 170.

The information can also include query information that is input at one vehicle 110 to ask passengers in the other vehicles 110 a question or to vote on a group decision, such as what restaurant to go to, when or where to stop of gas, lodging, a bathroom break, etc.

In another embodiment, the information can be (or can include) information input via a portable wireless communication device 295 that is presently in the vehicle and communicatively coupled (e.g., via a USB connection or Bluetooth link) to the onboard computer system 210 (e.g., a component of an infotainment system in a vehicle 110). For instance, the input may be received by way of a user interface, such as a touch screen, keypad, or speaker sub-system of a smart phone, laptop, or tablet computer. A user of a portable wireless communication device 295 could also provide such input by way of the Internet. For instance, this could be done via a personal or desktop computer, or from a mobile phone, via the cellular network and/or the Internet, and web site maintained by a service provider, such as OnStar®.

In another embodiment, the information can be (or can include) messaging or status information that is input by a passenger in a vehicle 110, for example, via an input device associated with the infotainment system, via a portable wireless communication device (e.g., smart phone) that is coupled to the infotainment system of the vehicle via a USB or Bluetooth connection, or via any other input device associated with the vehicle.

In another embodiment, the information can be (or can include) information generated by or associated with any applications that are running in a vehicle 110, such as, information generated by or associated with any applications that are running on (or being executed at) the onboard computer system 210 (e.g., a component of an infotainment system in the first vehicle 110-1). A few other non-limiting examples of information generated by or associated with any applications that are running at an onboard computer system of a vehicle can include, for example, information from a parking lot locator, information about driving efficiency from an application, etc.

In another embodiment, the information can be (or can include) information generated by applications that are running on a portable wireless communication device that is presently in the vehicle and communicatively coupled (e.g., via a USB connection or Bluetooth link) to the onboard computer system 210 (e.g., a component of an infotainment system in the vehicle 110). A few non-limiting examples of information generated by applications that are running on a portable wireless communication device that is presently in the vehicle can include, for example, audio information generated by an Internet Radio application, information generated by a 3^{rd} party navigation system, information generated by a virtual tour application, etc.

In another embodiment, the information can be (or can include) alert or warning information that is automatically generated by a vehicle 110 belonging to the group 120), and automatically communicated in an alert or warning message transmitted (or “pushed”) from that vehicle 110. In general, this alert information can include operational or safety-related information that relates to the vehicle 110. For instance, in some embodiments, alert information is automatically generated by the vehicles that belong to the group when any type of failure information is signaled within one of the vehicles (e.g., information about some potential failure in the vehicle, such as a low tire pressure warning, low fuel warning, engine oil pressure warning, low battery warning, brake system warning, engine coolant temperature warning, slick road warning). This information can indicate that there is a drastic change in some operating condition or that a potentially dangerous condition has been detected. Examples of alert or warning information can include a warning that tire pressure within one of the vehicles has become low or went to zero, a warning that speed of one of the vehicles has become low or went to zero, a warning that a crash sensor has been activated within one of the vehicles to indicate that that vehicle was involved in a crash, a warning that an engine trouble code has been generated within one of the vehicles, a warning that a low fuel level has been detected in one of the vehicles, a warning that any other type of failure information has been signaled within one of the vehicles, etc. This warning information can automatically be pushed to the other vehicles 110-2, 110-3 in the group 120 so that occupants are aware of the condition.

These are only a few non-limiting examples of the types of information that can be communicated among the vehicles 110 that belong to the group 120, and then displayed within the vehicles 110. Any combination of the information described above can be displayed together depending on the particular implementation. Two specific, non-limiting examples will be described below with reference to FIGS. 7 and 8.

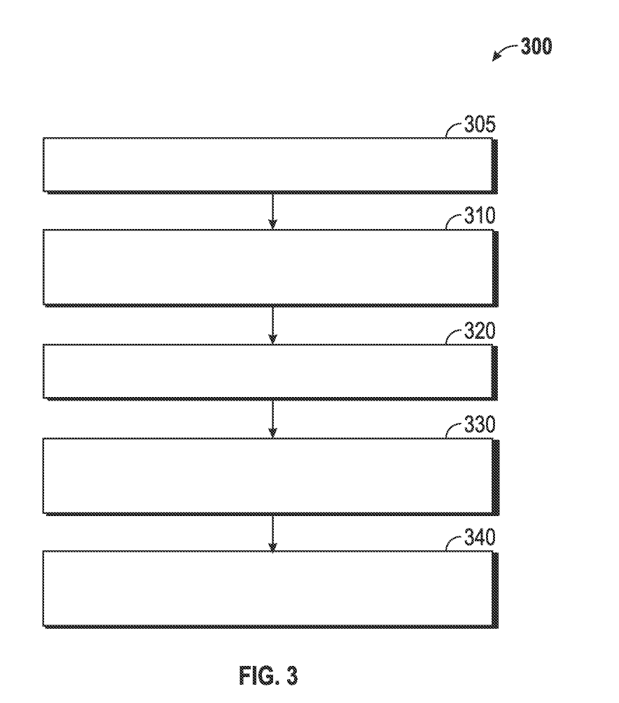

FIG. 3 is a flow chart of a method 300 for sharing information among a group of vehicles and displaying that information in each of the vehicles in accordance with some of the disclosed embodiments. FIG. 3 will be described below with reference to FIG. 1. It should be understood that steps of the method 300 are not necessarily presented in any particular order and that performance of some or all the steps in an alternative order is possible and is contemplated. The steps have been presented in the demonstrated order for ease of description and illustration. Further, steps can be added, omitted, and/or performed simultaneously without departing from the scope of the appended claims. It should also be understood that the illustrated method 300 can be ended at any time. In certain embodiments, some or all steps of this process, and/or substantially equivalent steps, are performed by execution of computer-readable instructions stored or included on a computer-readable medium, for example. For instance, references to a processor performing functions of the present disclosure refer to any one or more interworking computing components executing instructions, such as in the form of an algorithm, provided on a computer-readable medium, such as a memory associated with the processor of the onboard computer system 210 of any vehicle 110-1, 110-2, 110-3, of the remote server 170, or of a personal computing device 295.

At 305, a group leader creates the group 120 by designating vehicles that are invited to join the group 120. Those vehicles that are invited can then respond back whether or not they want to join the group 120. The group leader is an entity that controls which vehicles are invited and allowed to join the group 120. The group leader can be, for example, an intermediate or external network server 170 that is in communication with each vehicle of the group of vehicles 110-1 . . . 110-3. Alternatively, the group leader can be a server that is implemented at one of the vehicles (such as the vehicle 110-1 or any other vehicle that belongs to the group) that communicates directly with each other vehicle of the group of vehicles 110-1 . . . 110-3. Further, in some embodiments, in an optional invitation process, any one of the group of vehicles 110-1 . . . 110-3 is free to extend the “chain” of vehicles that are invited to join the group. In other words, any vehicle that is invited to join the group 120, can then invite other vehicles (not illustrated) to join the group 120.

At 310, a communication session is established among each of the vehicles 110-1 . . . 110-3 that have been invited to join the group, or among two or more particular ones of the vehicles 110-1 . . . 110-3 belong to the group of vehicles and that have opted to join (e.g., accepted an invitation to join) the group of vehicles.

This process for establishing a communication session among the group 120 can be accomplished many different ways. For instance, in one embodiment, the group leader can generate and distribute a unique key to member vehicles that are either invited to join or that have opted to join the group 120. The unique key is a shared secret (i.e., a piece of data such as a password, a passphrase, a big number or an array of randomly chosen bytes) that is known only to the vehicles are either invited to join or that have opted to join the group 120. This unique key can be used as part of an authentication process (e.g., challenge-response) between the particular group 120 of vehicles 110-1 . . . 110-3.

In one embodiment, to establish a communication session among the vehicles 110-1 . . . 110-3, the onboard computer system 210 of the first vehicle 110-1 (or anyone of the other vehicles 110-2, 110-3 that belong to the group 120) can initiate the communication session (e.g., when a group trip begins) by communicating an invite message to other vehicles that belong to the group, and can then allow them to opt in to join that communication session. This way, each vehicle that has been invited to join, and chooses to join the group, can communicate a message to the group leader to indicate that this vehicle has joined the group. In some embodiments, the onboard computer systems 210 at the recipient vehicles can prompt the user to join the communication session in any of a variety of ways, such as by making an input to the onboard computer system using any of the HMI sub-systems that are described above, which causes the onboard computer system within that vehicle to authenticate and become authorized to participate in sharing of information with any other vehicles that have joined that group 120.

At 320, one of the vehicles (e.g., the first vehicle 110-1 or any or all of the other vehicles 110-2, 110-3 that belong to the group 120) generates information that is to be shared among a particular group 120 of vehicles 110-1 . . . 110-3 that have opted to join the group 120. In one embodiment, this information can be encrypted using the unique key. In some embodiments, the unique key (or one of the unique keys) can optionally be used as part of an encryption process to help secure communications between the particular group 120 of vehicles 110-1 . . . 110-3. In some implementations, one or more of the unique key(s) can be used to derive a new encryption key for each communication or transaction. Alternatively, the unique key could be input to a key derivation function to produce one or more keys to use for encryption and/or MACing of messages.

At 330, the particular one of the vehicles (e.g., the first vehicle 110-1) that generated the information that is to be shared among a particular group 120 of vehicles 110-1 . . . 110-3 can then communicate the information (either directly or indirectly) to the other vehicles (e.g., other vehicles 110-2, 110-3) that have opted to join the group 120 and participate in the communication session at 310.

At 340, the information that was communicated at 330 can then be presented via a human machine interface (e.g., display and/or audio system) inside each of the other vehicles (e.g., other vehicles 110-2, 110-3) that have opted to join the group 120 and participate in the communication session at 310.

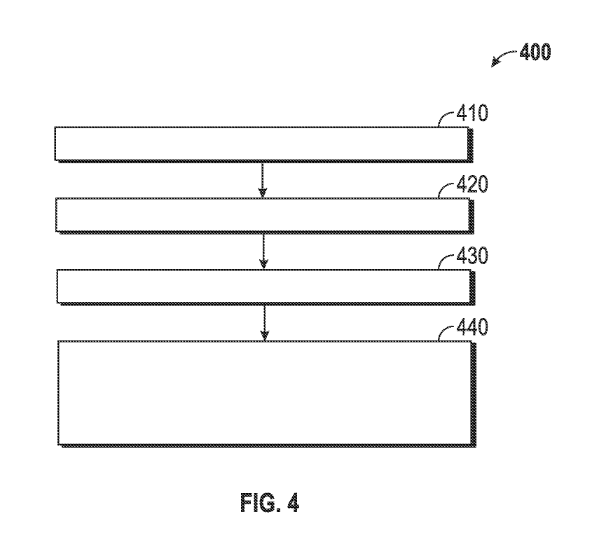

FIG. 4 is a flow chart of a method 400 for creating a group of vehicles and establishing a communication session among the group of vehicles in accordance with some of the disclosed embodiments. FIG. 4 will be described below with reference to FIG. 1. It should be understood that steps of the method 400 are not necessarily presented in any particular order and that performance of some or all the steps in an alternative order is possible and is contemplated. The steps have been presented in the demonstrated order for ease of description and illustration. Further, steps can be added, omitted, and/or performed simultaneously without departing from the scope of the appended claims. It should also be understood that the illustrated method 400 can be ended at any time. In certain embodiments, some or all steps of this process, and/or substantially equivalent steps, are performed by execution of computer-readable instructions stored or included on a computer-readable medium, for example. For instance, references to a processor performing functions of the present disclosure refer to any one or more interworking computing components executing instructions, such as in the form of an algorithm, provided on a computer-readable medium, such as a memory associated with the processor of the onboard computer system 210 of any vehicle 110-1, 110-2, 110-3, of the remote server 170, or of a personal computing device 295.

In one non-limiting embodiment, at 410, a group leader can create the group 120 of vehicles 110-1 . . . 110-3, for example, by creating a list of vehicles that are invited to join the group (at 410).

Optionally, in some implementations, at 420, an invitation or request can be sent (at 410) to each of the vehicles 110-1 . . . 110-3 to join the group, and only those vehicles that respond to the request by indicating that they would like to join the group will be considered in subsequent steps of method 400.

At 430, the group leader generates at least one unique key for the group 120; depending on the implementation, this key that is generated for each group member can be unique to that particular group member or unique key that is delivered to each member of the group. As noted above, the group leader can be implemented at one of the vehicles 110-1 . . . 110-3 or at an external server 170.

At 440, the group leader distributes the at least one unique key (along with a group identifier) to each of the vehicles that are invited to join the group 120 (or that have responded at 410 that they would like to join the group). Any vehicle that possesses the at least one unique key associated with the group identifier can then decide whether or not to join the group 120. In one embodiment, the group identifier and the at least one unique key can be distributed wirelessly over-the-air in real time or via an out-of-band means. The unique key can be shared beforehand between the communicating parties, in which case it can also be called a pre-shared key, or it can be created at the start of the communication session by using a key-agreement protocol (e.g., using public-key cryptography such as Diffie-Hellman or using symmetric-key cryptography such as Kerberos).

FIG. 5 is a flow diagram of a method 500 for pushing information from a first vehicle 110-1 to the other vehicles 110-2, 110-3 that belong to a group 120 of vehicles in accordance with some of the disclosed embodiments. FIG. 5 will be described below with reference to FIG. 1. In this regard it is noted that any communications illustrated as being directly between vehicles 110 can also traverse through an intermediate server that is communicatively linked to each of the vehicles 110.

At 510, the first vehicle 110-1 communicates information to the other vehicles 110-2, 110-3 that belong to the group 120. This information can be communicated in response to the occurrence of a specific event at the first vehicle 110-1 (e.g., each time certain information is generated or updated at the first vehicle 110-1). Alternatively, this information can be communicated periodically at regular intervals to provide regular updates. In general, the information communicated at 510 is multicast to each of the other vehicles 110-2, 110-3 that belong to the group 120 of vehicles. In some cases, the information may be communicated to a subset of the other vehicles 110-2, 110-3 that belong to the group 120. In some implementations, the information communicated at 510 is unicast to a particular one of the other vehicles 110-2, 110-3 that belong to the group 120. As shown at 520 and 530, each of the other vehicles 110-2, 110-3 that belong to the group 120 can also perform similar communications to those illustrated at 510) to share information with other vehicles 110-2, 110-3 that belong to the group 120.

FIG. 6 is a flow diagram of a method 600 for pulling information from a first vehicle 110-1 to distribute that information to the other vehicles 110-2, 110-3 that belong to a group 120 of vehicles in accordance with some of the disclosed embodiments. FIG. 6 will be described below with reference to FIG. 1.

At 610, one of the vehicles 110-2 that belong to the group communicates a request message to the first vehicle 110-1 to request that particular information (or a set of particular information) gets communicated to at least that vehicle 110-2 (or to all of the vehicles 110-2, 110-3 that belong to the group 120). In some implementations, the request can specify a sub-set of the group 120 that the particular information requested is to be communicated to. This request message can be communicated in response to: a user input, the occurrence of a specific event at the vehicle 110-2 (e.g., each time certain information is generated or updated at the vehicle 110-2), a time period elapsing since the last update (e.g., periodically at regular intervals), etc. In some implementations, the request communicated at 610 is unicast to the first vehicle 110-1.

In response to the request, the first vehicle 110-1 can communicate the information requested to at least the vehicle 110-2 (at 620), or to all vehicles that belong to the group 120 (at 620 and 630). In some implementations, the first vehicle 110-1 communicates the information requested in a unicast message to only the particular vehicle 110-2 that sent the request message at 610, whereas in other implementations, the first vehicle 110-1 communicates the information requested in a multicast message to all of the vehicles that belong to the group 120. In some cases, the information may be communicated to a subset of the other vehicles 110-2, 110-3 that belong to the group 120, but not necessarily all of the vehicles that belong to the group.

As shown at 640-660 and 670-690, each of the other vehicles 110-1 . . . 110-3 that belong to the group 120 can also perform similar communications to those illustrated at 610-630) to share information with other vehicles 110 that belong to the group 120.

FIGS. 7 and 8 show one non-limiting implementation of information that can be displayed on the displays of the first vehicle 110-1 and one of the other vehicles 110-2 that belong to group 120. FIGS. 7 and 8 will be described below with reference to FIG. 1. FIG. 7 is one non-limiting representation of information that can be presented at a user interface 700 on a display of an infotainment system in the first vehicle 110-1 in accordance with some of the disclosed embodiments. FIG. 8 is another non-limiting representation of information that can be presented at a user interface 800 on a display of an infotainment system in the second vehicle 110-2 in accordance with some of the disclosed embodiments.

As illustrated in FIG. 7, the user interface 700 in the first vehicle 110-1 shows names (Shane 155, Bob, Joe) associated with three vehicles 110-1, 110-2, 110-3, respectively, that belong to a group 120 that is traveling together in a caravan on a trip to Florida. The user interface 700 in the first vehicle 110-1 shows a map with graphical symbols that represent the relative locations of the vehicles 110-1 and 110-2 of Shane 155 and Bob on a map. The vehicle 110-3 of Joe is not illustrated in the map of FIG. 7.

In FIG. 7, next to the name Bob, a gas pump icon is displayed that indicates that both Bob and Shane are requesting a stop to re-fuel (e.g., obtain gas or charge a battery, etc.). This is also reflected in the icon at the bottom of the user interface that shows a gas pump with a circled number 2; this indicates that 2 vehicles of the group are requesting a particular action (e.g., a gas stop by pressing a gas pump button when requesting that other vehicles belonging to the group 120 also stop for gas). Here, another icon indicates that in this particular example that Bob is only 0.2 miles behind the lead vehicle. This way, the drivers of the vehicles 110-1, 110-3 know that Bob's vehicle 110-2 will soon need to stop to re-fuel, and can plan accordingly on when and where to stop.

As illustrated in FIG. 8, the user interface 800 in the other vehicle 110-2 shows names (Shane 155) associated with the first vehicle 110-1 and a map with a graphical symbol that represents the location of the vehicle 110-1 of Shane 155. The vehicles 110-2, 110-3 of Joe are not illustrated in the map of FIG. 8. Next to the name Shane 155 there is a gas pump icon that indicates that Shane 155 is requesting a stop to re-fuel his vehicle 110-1. In addition, below the name (Shane 155) associated with the first vehicle 110-1 there is information about the name of the song, band, radio station, and radio station name that is currently being played in the vehicle 110-1 of Shane 155. This way, the driver of the vehicle 110-2 knows what music Shane 155 is currently listening to.

Those of skill in the art would further appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the description above includes a general context of computer-executable instructions, the present disclosure can also be implemented in combination with other program modules and/or as a combination of hardware and software. The terms “application,” “algorithm,” “program,” “instructions,” or variants thereof, are used expansively herein to include routines, program modules, programs, components, data structures, algorithms, and the like, as commonly used. These structures can be implemented on various system configurations, including single-processor or multiprocessor systems, microprocessor-based electronics, combinations thereof, and the like. Although various algorithms, instructions, etc. are separately identified herein, various such structures may be separated or combined in various combinations across the various computing platforms described herein.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

The above-described embodiments are merely exemplary illustrations of implementations set forth for a clear understanding of the principles of the disclosure. The foregoing detailed description will provide those skilled in the art with a convenient road map for implementing the exemplary embodiment or exemplary embodiments. While exemplary embodiments have been presented in the foregoing detailed description, it should be appreciated that a vast number of variations exist.

The exemplary embodiments are only examples, and are not intended to limit the scope, applicability, or configuration of the disclosure in any way. Variations, modifications, and combinations may be made to the above-described embodiments without departing from the scope of the claims. For example, various changes can be made in the function and arrangement of elements without departing from the scope of the disclosure as set forth in the appended claims and the legal equivalents thereof. All such variations, modifications, and combinations are included herein by the scope of this disclosure and the following claims.

What is claimed is:

1. A computer-implemented method for sharing information between a group of vehicles, the method comprising:
at each of the vehicles belonging to the group of vehicles:
generating information at a processor;
communicating, via a wireless communication interface, the information to the other vehicles in the group of vehicles;
receiving, via the wireless communication interface, the information communicated from each of the other vehicles;
processing, at the processor, the information received from each of the other vehicles; and
presenting, via a human machine interface located in that particular vehicle, the information received from each of the other vehicles.

2. A computer-implemented method according to claim 1, wherein the information comprises:
metadata for any information about the first vehicle that indicates something that is happening inside the first vehicle.

3. A computer-implemented method according to claim 2, wherein the metadata indicates information about an infotainment system of the first vehicle comprising:
setting information that indicates a setting of the infotainment system.

4. A computer-implemented method according to claim 1, wherein the information comprises:
information about the first vehicle that is available on a bus within the first vehicle.

5. A computer-implemented method according to claim 4, wherein the information available on the bus comprises:
diagnostic information about the first vehicle that is generated within the first vehicle.

6. A computer-implemented method according to claim 1, wherein the information comprises:
navigation data associated with the first vehicle, comprising:
location information indicative of a relative location of the first vehicle with respect to the one or more other vehicles, comprising: a speed and heading of the first vehicle; and
wherein the step of presenting comprises:
displaying, on a display in each of the other vehicles, the location information on a map along with:
a location of each of the one or more other vehicles that belong to the group of vehicles, the locations comprising:
distances between each of the one or more other vehicles that belong to the group of vehicles, and
directions of travel of each of the vehicles that belong to the group of vehicles.

7. A computer-implemented method according to claim 1, wherein the information comprises:
information generated by applications that are running on a portable wireless communication device that is located in the first vehicle.

8. A computer-implemented method according to claim 1, further comprising:
creating the group of vehicles, wherein the step of creating comprises:
generating at least one unique key for the group at a group leader;
distributing the at least one unique key to each of the vehicles that are invited to join the group; and
at each vehicle that chooses to join the group:
inputting the at least one unique key and communicating a message to the group leader to indicate that this vehicle has joined the group, wherein each vehicle of the group of vehicles has opted to share information with other vehicles in the group.

9. A system comprising a group of vehicles that are configured to share information with each other after joining the group, wherein each vehicle belonging to the group of vehicles comprises:
a processor that is configured to generate information that is to be shared with other vehicles belonging to the group of vehicles;
a wireless communication interface that is configured to communicate the information to each of the other vehicles belonging to the group of vehicles; and to receive the information communicated from each of the other vehicles, wherein the processor is further configured to process the information received from each of the other vehicles belonging to the group of vehicles; and
a human machine interface that is configured to present the information received from each of the other vehicles belonging to the group of vehicles.

10. A system according to claim 9, wherein the information comprises:
metadata for any information about the first vehicle that indicates something that is happening inside the first vehicle.

11. A system according to claim 10, wherein the metadata indicates information about an infotainment system of the first vehicle comprising:
setting information that indicates a setting of the infotainment system.

12. A system according to claim 9, wherein the information comprises:
information about the first vehicle that is available on a bus within the first vehicle.

13. A system according to claim 12, wherein the information available on the bus comprises:
diagnostic information about the first vehicle that is generated within the first vehicle.

14. A system according to claim 9, wherein the information comprises:
navigation data associated with the first vehicle, the navigation data comprising: location information indicative of a relative location of the first vehicle with respect to the one or more other vehicles, and a speed of the first vehicle; and
wherein each human machine interface comprises:
a display that is configured to display the location information received from each of the other vehicles belonging to the group of vehicles on a map along with a location and speed of each of the one or more other vehicles that belong to the group of vehicles.

15. A system according to claim 9, wherein the information comprises:
information generated by applications that are running on a portable wireless communication device that is located in the first vehicle.

16. A system according to claim 9, further comprising:
a group leader configured to create the group of vehicles by generating at least one unique key for the group, and distributing the at least one unique key to each of the vehicles that are invited to join the group, wherein each vehicle that chooses to join the group opts to share the information with other vehicles in the group by inputting the at least one unique key and communicating a message to the group leader to indicate that this vehicle has joined the group.

17. A computer-implemented method for sharing information between a group of vehicles that have opted to share information with other vehicles in the group, wherein the group comprises a first vehicle and one or more other vehicles, the computer-implemented method comprising:
generating information at a first processor within the first vehicle;
communicating, via a first wireless communication interface within the first vehicle, the information to the one or more other vehicles; and
at each of the one or more other vehicles:
receiving the information via a second wireless communication interface;
processing the information at a second processor; and
presenting the information via a human machine interface.

18. A computer-implemented method according to claim 17, wherein the information comprises:
metadata for any information about the first vehicle that indicates something that is happening inside the first vehicle.

19. A computer-implemented method according to claim 18, wherein the metadata comprises:
information generated by or associated with any applications that are running on a processor located within the first vehicle; and
information that indicates a setting of an infotainment system of the first vehicle; and
diagnostic information available on a bus within the first vehicle that is generated by at least one system within the first vehicle.

20. A vehicle configured to communicate with a group of other vehicles that have opted to belong to the group and share information with each other, wherein the vehicle comprises:
a processor that is configured to generate information that is to be shared with the other vehicles belonging to the group of vehicles;
a wireless communication interface that is configured to:
communicate the information to each of the other vehicles belonging to the group of vehicles; and
receive other information communicated from each of the other vehicles, wherein the processor is further configured to process the other information received from each of the other vehicles; and
a human machine interface that is configured to present the other information received from each of the other vehicles.
